(19) United States
(12) Patent Application Publication
(10) Pub. No.: US 2025/0115064 A1
(43) Pub. Date: Apr. 10, 2025

(54) SHEET CONVEYANCE APPARATUS

(71) Applicant: CANON KABUSHIKI KAISHA, Tokyo (JP)

(72) Inventors: KOHEI AOKI, Chiba (JP); SHUTARO SAITO, Tokyo (JP); HIROSHI KOKUBO, Tokyo (JP); TAKUMA TADOMI, Chiba (JP); YUSHI SADAMITSU, Tokyo (JP)

(21) Appl. No.: 18/892,750

(22) Filed: Sep. 23, 2024

(30) Foreign Application Priority Data
Oct. 6, 2023 (JP) 2023-174638

(51) Int. Cl. B41J 13/08; B41J 11/00; B41J 13/03

(52) U.S. Cl. CPC B41J 13/08; B41J 11/00244; B41J 13/03

(57) ABSTRACT

A sheet conveyance apparatus includes a first belt unit including a first belt, a second belt unit including a second belt that forms a nip portion for nipping and conveying a sheet with the first belt. The second belt unit includes at least one nip portion forming member forming the nip portion between the first belt and the second belt by abutting on an inner peripheral surface of the second belt and supporting the second belt, at least three supporting members disposed along a conveyance direction of the sheet in the nip portion, the at least three supporting members being in contact with surfaces of the nip portion forming member on a side opposite to the second belt at different positions in a width direction to support the nip portion forming member, and at least one connecting member connecting the at least three supporting members.

### BACKGROUND OF THE INVENTION

### Field of the Invention

The present disclosure relates to a sheet conveyance apparatus that conveys a sheet.

### Description of the Related Art

Japanese Patent Application Laid-Open Publication No. 2020-15290 describes a configuration in which a sheet is heated by a heater while the sheet is nipped and conveyed by a pair of belts.

### SUMMARY OF THE INVENTION

According to one aspect of the present invention, a sheet conveyance apparatus includes a first belt unit including a rotating endless first belt, a second belt unit including a rotating endless second belt that forms a nip portion for nipping and conveying a sheet with the first belt. The first belt unit includes the first belt, and plurality of first stretching members configured to stretch the first belt. The second belt unit includes the second belt, a plurality of second stretching members configured to stretch the second belt, at least one nip portion forming member configured to form the nip portion between the first belt and the second belt by abutting on an inner peripheral surface of the second belt and supporting the second belt, at least three supporting members disposed along a conveyance direction of the sheet in the nip portion, the at least three supporting members being in contact with surfaces of the nip portion forming member on a side opposite to the second belt at different positions in a width direction of the sheet intersecting with the conveyance direction to support the nip portion forming member, and at least one connecting member configured to connect the at least three supporting members.

Further features of the present invention will become apparent from the following description of exemplary embodiments with reference to the attached drawings.

### BRIEF DESCRIPTION OF THE DRAWINGS

FIG. 1 is a schematic configuration cross-sectional view illustrating an image forming system according to a first embodiment.

FIG. 2 is a schematic configuration cross-sectional view illustrating a fixing module according to the first embodiment.

FIG. 3 is a schematic configuration cross-sectional view illustrating a fixing belt unit according to the first embodiment.

FIG. 4 is a perspective view illustrating a configuration of a steering unit of the fixing belt unit according to the first embodiment.

FIG. 5 is a plan view illustrating a relationship between a belt and an edge sensor according to the first embodiment.

FIG. 6 is a schematic configuration cross-sectional view illustrating a configuration of a pad holder of the fixing belt unit according to the first embodiment in an exaggerated manner.

FIG. 7 is a view for explaining a crown shape of a pad.

FIG. 8 is a perspective view of the pad holder according to the first embodiment.

FIG. 9 is a perspective view of the pad according to the first embodiment as viewed from a back side.

FIG. 10 is a schematic configuration cross-sectional view illustrating a configuration of a pad holder of a fixing belt unit according to a second embodiment in an exaggerated manner.

FIG. 11 is a schematic configuration cross-sectional view illustrating a configuration of a pad holder of a fixing belt unit according to a third embodiment in an exaggerated manner.

### DESCRIPTION OF THE EMBODIMENTS

### First Embodiment

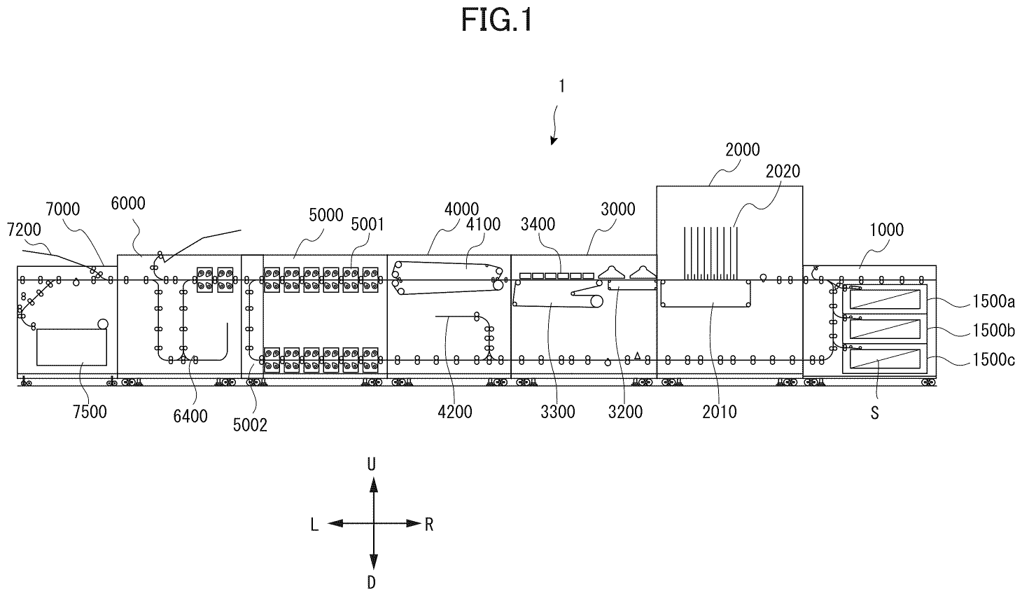

A first embodiment will be described with reference to FIGS. 1 to 9. First, a schematic configuration of an image forming system of the present embodiment will be described with reference to FIG. 1.

### Image Forming System

The image forming system 1 serving as an image forming apparatus of the present embodiment uses an inkjet recording system that ejects ink to form an image on a sheet, and is a so-called sheet-type inkjet recording apparatus that forms an ink image on a sheet using two liquids of a reaction liquid and ink. The sheet may be, for example, a recording material capable of receiving ink, such as paper such as plain paper or thick paper, a plastic film such as a sheet for an overhead projector, a sheet having a special shape such as an envelope or index paper, and cloth.

As illustrated in FIG. 1, the image forming system 1 of the present embodiment includes a feeding module 1000, a print module 2000, a drying module 3000, a fixing module 4000, a cooling module 5000, a reverse module 6000, and a stacking module 7000. When the sheet S supplied from the feeding module 1000 is conveyed along a conveyance path in each module, various processing is performed, and the sheet S is finally discharged to the stacking module 7000.

Note that the feeding module 1000, the print module 2000, the drying module 3000, the fixing module 4000, the cooling module 5000, the reverse module 6000, and the stacking module 7000 may have separate casings, and these casings may be connected to configure the image forming system 1. Alternatively, the feeding module 1000, the print module 2000, the drying module 3000, the fixing module 4000, the cooling module 5000, the reverse module 6000, and the stacking module 7000 may be disposed in one casing.

The feeding module 1000 includes storage compartments 1500a, 1500b, and 1500c that store the sheet S, and the storage compartments 1500a to 1500c are provided to be drawable toward the front side of the apparatus in order to store the sheet S. The sheets S are fed one by one by a separation belt and a conveying roller in each of the storage compartments 1500a to 1500c, and conveyed to the print module 2000. The number of storage compartments 1500a to 1500c is not limited to 3, and may be 1, 2, or 4 or more.

The print module 2000 serving as an image forming unit includes a pre-image formation registration correction unit (not illustrated), a print belt unit 2010, and a recording unit 2020. The sheet S conveyed from the feeding module 1000 is corrected an inclination and a position of the sheet S by the pre-image formation registration correction unit and conveyed to the print belt unit 2010. The recording unit 2020 is disposed at a position facing the print belt unit 2010 across the conveyance path. The recording unit 2020 is an inkjet recording unit that forms an image by ejecting ink onto the sheet S by a recording head from above with respect to the conveyed sheet S. A plurality of recording heads that eject ink is arranged along a conveyance direction. In the present embodiment, in addition to four colors of yellow (Y), magenta (M), cyan (C), and black (Bk), a total of five line type recording heads corresponding to the reaction liquid are provided. The sheet S is sucked and conveyed by the print belt unit 2010 to secure a clearance with the recording head.

Note that the number of colors of ink and the number of recording heads are not limited to the above-described five. As the inkjet method, a method using a heat generating element, a method using a piezoelectric element, a method using an electrostatic element, a method using a micro electro mechanical systems (MEMS) element, and the like can be adopted. The ink of each color is supplied from each ink tank (not illustrated) to each recording head via each ink tube. The ink contains “0.1 mass % to 20.0 mass %” of a resin component, water, a water-soluble organic solvent, a coloring material, wax, an additive, and the like on the basis of the total mass of the ink.

When the sheet S on which an image is formed by the recording unit 2020 is conveyed by the print belt unit 2010, deviation and color density of the image formed on the sheet S are detected by an in-line scanner (not illustrated) arranged downstream of the recording unit 2020 in the conveyance direction of the sheet S. Based on the deviation and the color density of the image detected by the in-line scanner, deviation of an image, density of an image, and the like to be formed on the sheet S are corrected.

The drying module 3000 includes a decoupling unit 3200, a drying belt unit 3300, and a warm air blowing unit 3400. The drying module 3000 reduces the liquid content of the ink and the reaction liquid applied to the sheet S in order to enhance the fixability of the ink to the sheet S by the subsequent fixing module 4000. The sheet S on which the image is formed is conveyed to the decoupling unit 3200 disposed in the drying module 3000. In the decoupling unit 3200, a frictional force is generated between the sheet S and the belt by the wind pressure of the wind blown from above, and the sheet Sis conveyed by the belt. In this way, by conveying the sheet S placed on the belt by frictional force, deviation of the sheet S when the sheet S is conveyed over the print belt unit 2010 and the decoupling unit 3200 is prevented. The sheet S conveyed from the decoupling unit 3200 is sucked and conveyed by the drying belt unit 3300, and the hot air is blown from the warm air blowing unit 3400 disposed above the belt to dry the ink and the reaction liquid applied to the sheet S.

In this way, the ink and the reaction liquid applied to the sheet S are heated by the drying module 3000 and the evaporation of the moisture is promoted, so that it is possible to suppress the occurrence of so-called cockling in which a line like a border is formed around the sheet S by splashing the ink on the sheet S. As the drying module 3000, any device may be used as long as the device can perform heating and drying. For example, a hot air dryer or a heater is preferable. As the heater, for example, heating by an electric heating wire or an infrared heater is preferable from the viewpoint of safety and energy efficiency.

The fixing module 4000 serving as a fixing system includes a fixing belt unit 4100 serving as a fixing unit. The fixing belt unit 4100 causes the sheet S conveyed from the drying module 3000 to pass between a heated upper belt unit and lower belt unit to fix the ink to the sheet S. The fixing belt unit 4100 will be described in detail below.

The cooling module 5000 includes a plurality of cooling units 5001, and cools the high-temperature sheet S conveyed from the fixing module 4000 by the cooling units 5001. For example, each of the cooling units 5001 takes outside air into a cooling box by a fan to increase the pressure in the cooling box, and blows air blown from the cooling box through the nozzle by the pressure against the sheet S to cool the sheet S. The cooling units 5001 are disposed on each of both sides of the conveyance path of the sheet S and cools both surfaces of the sheet S.

A conveyance path switching unit 5002 is provided in the cooling module 5000. The conveyance path switching unit 5002 switches the conveyance path of the sheet S according to the case of conveying the sheet S to the reverse module 6000 and the case of conveying the sheet S to a duplex conveyance path for duplex printing for forming an image on both surfaces of the sheet S.

The reverse module 6000 includes a reverse portion 6400. The reverse portion 6400 reverses the front and back sides of the conveyed sheet S and changes the front and back sides of the sheet S when the sheet S is discharged to the stacking module 7000. The stacking module 7000 includes a top tray 7200 and a stacking portion 7500, and stacks the sheet S conveyed from the reverse module 6000.

During duplex printing, the sheet S is conveyed to a conveyance path below the cooling module 5000 by the conveyance path switching unit 5002. Thereafter, the sheet S is returned to the print module 2000 through the duplex conveyance path of the fixing module 4000, the drying module 3000, the print module 2000, and the feeding module 1000. A reverse portion 4200 that reverses the front and back of the sheet S is provided in a duplex conveying portion of the fixing module 4000. The sheet S returned to the print module 2000 has an image formed by ink on the other surface on which no image is formed, and is discharged to the stacking module 7000 through the drying module 3000, the fixing module 4000, the cooling module 5000, and the reverse module 6000.

### Fixing Module

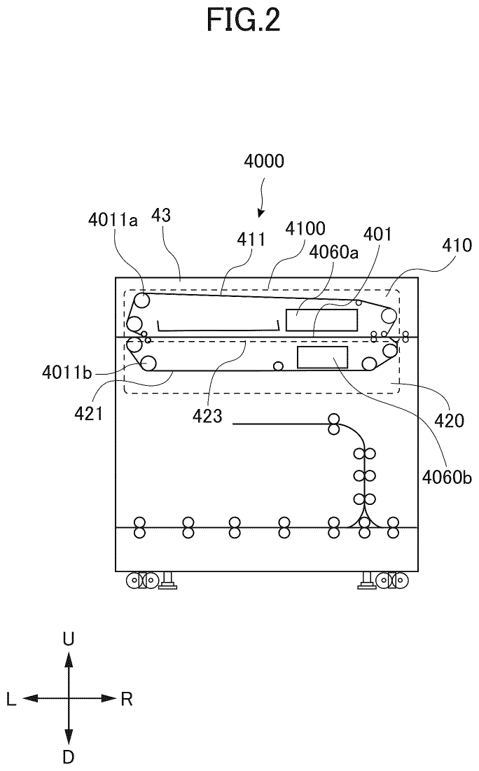

Next, the fixing module 4000 will be described in detail with reference to FIG. 2. FIG. 2 is a schematic view illustrating the fixing module 4000. The fixing belt unit 4100 is provided at the upper portion of the fixing module 4000. The fixing belt unit 4100 has a substantially linear sheet conveyance path 401 for receiving the sheet S discharged from the drying module 3000, fixing the sheet S, and then delivering the sheet S to the cooling module 5000. In each drawing, a front side of the image forming system 1 is referred to as a front direction F, a back side thereof is referred to as a rear direction B, a right side thereof as viewed from the front is referred to as a rightward direction R, a left side thereof as viewed from the right is referred to as a left direction L, an upper side thereof is referred to as an up direction U, and a lower side thereof is referred to as a down direction D. An operation unit (not illustrated) operated by an operator is provided on the front side of the image forming system 1.

The fixing belt unit 4100 includes an upper belt unit 410 and a lower belt unit 420. The upper belt unit 410 is disposed vertically above the lower belt unit 420. The upper belt unit 410 includes an upper belt 411 that is an example of a fixing belt and a conveyor belt (first conveyor belt), and a tension roller 4011a that applies tension to the upper belt 411. That is, the upper belt unit 410 is an example of a belt unit (first belt unit), and detachably includes the upper belt 411 that conveys the sheet S. The lower belt unit 420 is an example of a second belt unit, and includes a lower belt 421, a tension roller 4011b that applies tension to the lower belt 421, and a pad 423 having an arc-shaped curved surface. The pad 423 serving as a nip portion forming member is disposed so as to form a nip with the upper belt 411 via the lower belt 421.

The sheet S is nipped and conveyed between the upper belt unit 410 and the lower belt unit 420. That is, the lower belt 421 is an example of a rotary member and a second conveyor belt, and is arranged to face the upper belt unit 410 when an upper door unit 43 is located at a closed position and the upper belt unit 410 is located at the upper storage position. At this time, the lower belt 421 nips and conveys the sheet S together with the upper belt 411. The pressure of the nip is determined by the tension and thickness of the upper belt 411 and the curvature of the pad 423. When the pressure of the nip is too high, there is a possibility that the ink on the sheet S adheres to the upper belt unit 410 and a phenomenon in which the ink is peeled off from the sheet S occurs. Therefore, the pressure is preferably 1 Pa to 2,000 Pa, and more preferably 1 Pa to 200 Pa.

When the curvature of the pad 423 increases, a difference in distances of conveyance paths between the front and back sides of the sheet S increases, and there is a possibility that rubbing occurs between the sheet S and the belt. When the curvature of the pad 423 increases, there is a possibility that a phenomenon occurs in which the sheet S itself memorizes the curved surface shape and curls, so that a curvature radius of the pad 423 is desirably 50 mm or more. In addition, in the curvature radius of the pad 423, it is desirable that the curvature radius is 100,000 mm or less from the viewpoint of manufacturing accuracy. Due to these restrictions, in the present embodiment, the tension of the upper belt 411 is set to 200 N, the thickness of the upper belt 411 is set to 0.3 mm, the curvature radius of the pad 423 is set to 30,000 mm, and the pressure of the nip is set to about 16 Pa.

By adopting such a configuration, even a wide nip can be uniformly pressurized. As a result, even in a state where the temperature of the upper belt unit 410 is set to the wax melting point or the boiling point temperature of water, heat transfer to the sheet S can be sufficiently performed by increasing the contact time between the sheet S and the upper belt unit 410. However, when the nip is continuously formed after the heat is sufficiently transferred, a phenomenon in which the ink adheres to the upper belt 411 and peels off from the sheet S or a phenomenon in which the upper belt 411 and the sheet S are rubbed with each other and the image is disturbed occurs. Therefore, an excessively long contact time is not preferable. Therefore, the time required for the leading end of the sheet S to enter the inlet of the nip and exit from the outlet of the nip is desirably 0.5 s to 4 s. In the present embodiment, the pad having a length of 900 mm in the sheet conveyance direction is used as the pad 423, the sheet S is conveyed at 700 mm/s, and the time required from when the leading end of the sheet S enters the inlet of the nip to when the leading end of the sheet S passes through the outlet of the nip is set to about 1.3 s. Since moisture is necessary when the ink penetrates into the sheet S, the upper belt 411 and the lower belt 421 are preferably impermeable to moisture so that moisture evaporated from the surface of the sheet S does not escape through the contact upper belt 411 or lower belt 421 when the sheet becomes high temperature.

### Fixing Belt Unit

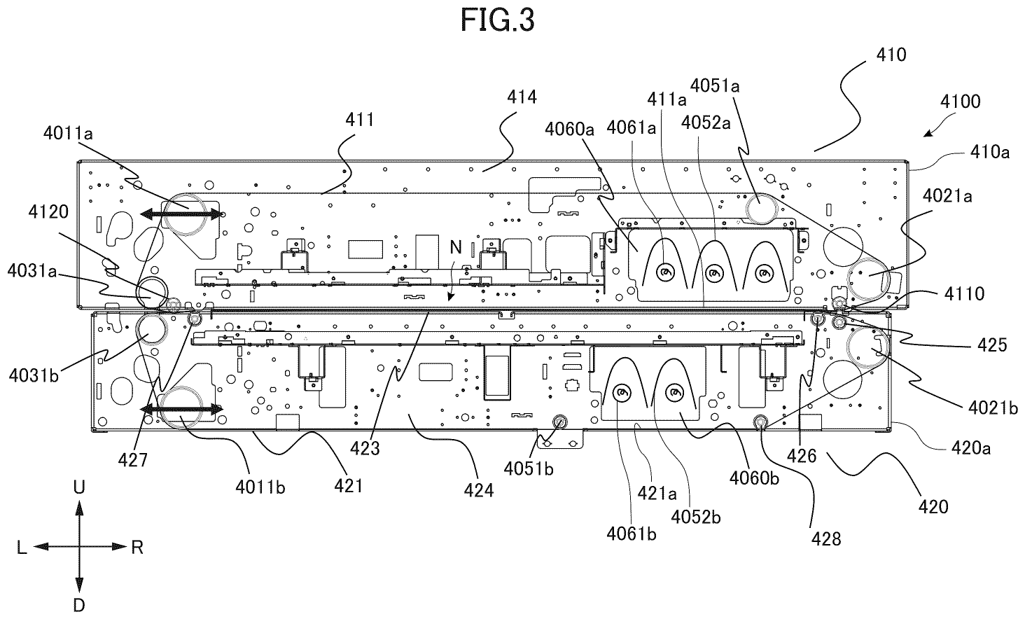

Next, the fixing belt unit 4100 of the present embodiment will be described with reference to FIG. 3. As illustrated in FIG. 3, the fixing belt unit 4100 serving as the sheet conveyance apparatus and the fixing unit includes an upper belt unit 410 serving as a first belt unit and a lower belt unit 420 serving as a second belt unit, and the upper belt 411 of the upper belt unit 410 and the lower belt 421 of the lower belt unit 420 are brought into pressure contact with each other to form the nip portion N. The sheet S1 is nipped and conveyed by the nip portion N, and the image formed by the ink is fixed on the sheet S1 by applying pressure and heat at that time.

The upper belt unit 410 includes the endless upper belt 411 serving as a belt and a first belt, a plurality of stretching rollers serving as a plurality of first stretching members that stretch the upper belt 411, and a first heating unit 4060a serving as a first heating device. The plurality of stretching rollers are an inlet roller 4110, an outlet roller 4120, a driving roller 4031a, the tension roller 4011a, a guide roller 4051a, and a steering roller 4021a. Each of these rollers is arranged in order from the upstream side of the nip portion N with respect to the rotation direction of the upper belt 411, and a rotation trajectory of the upper belt 411 is thereby formed. Further, the nip portion N exists between the inlet roller 4110 and the outlet roller 4120. Each roller is supported by an upper frame 414 which is a casing of the upper belt unit 410.

The first heating unit 4060a is disposed inside the upper belt 411, and includes a first heater portions 4061a and a reflecting plates 4052a serving as a reflecting members and a first reflecting members. The first heating unit 4060a is detachable from the first belt unit main body 410a including the upper belt 411. The first belt unit main body 410a includes the upper belt 411, a plurality of rollers that stretch the upper belt 411, and the upper frame 414.

The first heater portions 4061a are arranged in a non-contact manner with respect to the upper belt 411 and along a width direction of the upper belt 411 intersecting the rotation direction of the upper belt 411, and heat the upper belt 411 by radiating heat. The reflecting plates 4052a are disposed along the width direction, and reflect radiant heat of first heater portions 4061 a toward a predetermined region of upper belt 411.

In the present embodiment, the first heating unit 4060a of the upper belt unit 410 is disposed inside the upper belt 411 and above the nip portion N, and heats the upper belt 411 from inside. The first heating unit 4060a includes a plurality of first heater portions 4061a. In the present embodiment, three first heater portions 4061a are arranged side by side in the rotation direction of the upper belt 411. The reflecting plates 4052a are disposed so as to cover a periphery of first heater portions 4061a other than a side facing upper belt 411, respectively.

The same number of reflecting plates 4052a as the number of the first heater portions 4061a are arranged corresponding to the first heater portions 4061a. Further, the reflecting plates 4052a are formed so that the nip portion N side of the first heater portions 4061a are opened and so as to cover both end portions of the first heater portions 4061a in the width direction. Accordingly, the reflecting plates 4052a efficiently irradiate the nip portion N with radiant heat of the first heater portions 4061a.

That is, in the upper belt unit 410, the predetermined region is a region (first region) in the range of the nip portion N on the inner peripheral surface of the upper belt 411, and the nip portion N is directly heated by the plurality of first heater portions 4061a and the plurality of reflecting plates 4052a. As a result, heat can be efficiently transferred to the sheet S passing through the nip portion N. In the present embodiment, a region in the range of the nip portion N heated by the plurality of first heater portions 4061a is the inner peripheral surface (lower surface portion) of the upper belt 411, and is the lower surface portion 411a located upstream of the central position of the nip portion N with respect to the conveyance direction of the sheet S passing through the nip portion N. That is, in the present embodiment, the predetermined region in the upper belt unit 410 is the lower surface portion 411a.

The lower surface portion 411a is a position facing the lower belt 421 stretched between a nip upstream roller 426 and a nip downstream roller 427 among the stretching rollers of the lower belt 421 to be described below, and is a position facing a region where the lower belt 421 is supported by the pad 423 arranged between these rollers. Thus, the distance between the lower surface portion 411a of the upper belt 411 and the first heating unit 4060a is kept substantially constant regardless of the rotation of the upper belt 411.

The lower belt unit 420 includes an endless lower belt 421 serving as a belt and a second belt, a plurality of stretching rollers serving as a plurality of second stretching members for stretching the lower belt 421, and a second heating unit 4060b serving as a second heating device. The plurality of stretching rollers are a nip upstream guide roller 425, a nip upstream roller 426, a nip downstream roller 427, a driving roller 4031b, the tension roller 4011b, a guide roller 4051b, a guide roller 428, and a steering roller 4021b. These rollers are arranged in order from the upstream side of the nip portion N in the rotation direction of the lower belt 421.

In addition, between the nip upstream roller 426 and the nip downstream roller 427, the nip portion N exists and a pad 423 is disposed. That is, the nip upstream roller 426 and the nip downstream roller 427 are disposed so as to sandwich the nip portion N in the rotation direction of the lower belt 421. Then, the pad 423 serving as a nip portion forming member abuts on the inner peripheral surface in the region of the nip portion N of the lower belt 421 to support the lower belt 421, thereby forming the nip portion N between the upper belt 411 and the lower belt 421. A rotation trajectory of the lower belt 421 is formed by the rollers and the pad 423. Each roller and pad 423 are supported with respect to a lower frame 424 which is a casing of the lower belt unit 420.

The second heating unit 4060b is disposed inside the lower belt 421, and includes a second heater portions 4061b and a reflecting plates 4052b serving as a reflecting members and a second reflecting members. The second heating unit 4060b is detachable from the second belt unit main body 420a including the lower belt 421. The second belt unit main body 420a includes the lower belt 421, a plurality of rollers that stretch the lower belt 421, the pad 423, and the lower frame 424.

The second heater portions 4061b are arranged in a non-contact manner with respect to the lower belt 421 and along the width direction of the lower belt 421 intersecting the rotation direction of the lower belt 421, and heat the lower belt 421 by radiating heat. The reflecting plates 4052b are disposed along the width direction, and reflect radiant heat of second heater portions 4061b toward a predetermined region of the lower belt 421.

In the present embodiment, the second heating unit 4060b of the lower belt unit 420 is disposed inside the lower belt 421 and below the nip portion N, and heats the lower belt 421 from inside. The second heating unit 4060b includes the plurality of second heater portions 4061b. In the present embodiment, two second heater portions 4061b are arranged side by side in the rotation direction of the lower belt 421. The reflecting plates 4052b are disposed so as to cover a periphery of second heater portions 4061b other than a side facing the lower belt 421, respectively.

The reflecting plates 4052b having the same number as that of the second heater portions 4061b are arranged corresponding to the second heater portions 4061b. The reflecting plates 4052b are formed so as to open below the second heater portions 4061b and to cover both end portions of the second heater portions 4061b in the width direction. Thus, the reflecting plates 4052b efficiently irradiate the lower portion of the lower belt 421 with the radiant heat of the second heater portions 4061b.

That is, in the lower belt unit 420, the predetermined region is a region (second region) out of the nip portion N in the inner peripheral surface of the lower belt 421, and is a lower portion of the lower belt 421 in the present embodiment. Specifically, a region that is heated by the plurality of second heater portions 4061b and is out of the nip portion N is the inner peripheral surface (lower surface portion) of the lower belt 421 extending between the guide roller 4051b and the guide roller 428 in the rotation direction of the lower belt 421. That is, the predetermined region in the lower belt unit 420 is the lower surface portion 421a of the lower belt 421, and the lower surface portion 421a is a surface on which the lower belt 421 is stretched in the substantially horizontal direction by the guide roller 4051b and the guide roller 428. In the lower belt unit 420, the pad 423 is provided at a position corresponding to the nip portion N as described above, and the nip portion N cannot be directly heated unlike the upper belt unit 410. Therefore, by disposing the plurality of second heater portions 4061b and the plurality of reflecting plates 4052b toward the lower surface portion 421a of the lower belt 421, the lower belt 421 is directly heated efficiently.

The lower surface portion 421a, which is a region of the lower belt 421 heated by the plurality of second heater portions 4061b and the plurality of reflecting plates 4052b, is disposed upstream of the nip upstream guide roller 425 arranged at the inlet of the nip portion N and downstream of the steering roller 4021b in the rotation direction of the lower belt 421. The lower surface portion 421a is located on the downstream side in the rotation direction of the lower belt 421 with respect to the central position between the guide roller 428 that stretches the lower portion of the lower belt 421 and the tension roller 4011b. Therefore, the lower belt 421 can be heated at a position relatively close to the nip portion N by the plurality of second heater portions 4061b and the plurality of reflecting plates 4052b, and heat can be efficiently transferred to the sheet S passing through the nip portion N.

In the upper belt unit 410, as described above, the distance between the upper belt 411 and the first heating unit 4060a is kept substantially constant by the pad 423 regardless of the rotation of the upper belt 411. Accordingly, the thermal influence from first heater portions 4061a to upper belt 411 is stabilized. In the lower belt unit 420, the tension roller 4011b stretches the lower belt 421 at the position located upstream of the second heating unit 4060b and the guide roller 428 stretches the lower belt 421 at the position located downstream of the second heating unit 4060b, so that the distance between the lower belt 421 and the second heating unit 4060b is kept substantially constant regardless of the rotation of the lower belt 421. As a result, the thermal influence from the second heater portion 4061b to the lower belt 421 is stabilized.

The first heater portions 4061a and the second heater portions 4061b may be heaters that heat the belt by radiating heat, and are, for example, halogen heaters. In the present embodiment, these heaters are halogen heaters.

As described above, the reflecting plates 4052a and 4052b are disposed around the first heater portions 4061a and the second heater portions 4061b, respectively, to efficiently collect light to the upper belt 411 and the lower belt 421. In order to efficiently reflect light, for example, a mirror-finished aluminum member or the like is used for the reflecting plates 4052a and 4052b. The output of the heaters of the plurality of first heater portions 4061a and the plurality of second heater portions 4061b is controlled based on the temperature detected by a temperature detection unit (not illustrated). Thus, the temperatures of the upper belt 411 and the lower belt 421 are appropriately maintained.

In the present embodiment, as a preferred example, the belt is directly heated from the inside by the halogen heater, but the heater may be configured using a planar heating element or an IH. Alternatively, a heating roller made of aluminum or the like incorporating a halogen heater or the like may be brought into contact with the belt to indirectly heat the belt, or the belt may be heated from the outer surface.

### Stretching Roller of Each Belt Unit

The tension rollers 4011a and 4011b, the steering rollers 4021a and 4021b, and the driving rollers 403 la and 403 1b of the upper belt unit 410 and the lower belt unit 420 described above will be described. Since the functions of these rollers are the same between the upper belt unit 410 and the lower belt unit 420, the roller of the lower belt unit 420 will be described below as an example.

### Tension Roller

First, the tension roller 4011b will be described with reference to FIG. 3. One of the plurality of stretching rollers provided in the lower belt unit 420 is the tension roller 4011b that applies tension to the lower belt 421. The tension roller 4011b is disposed on a surface (down direction D) opposite to a surface (up direction U) forming the nip portion N, and stretches the lower belt 421. In the present embodiment, the tension roller 4011b is disposed downstream of the nip downstream roller 427 of the nip upstream roller 426 and the nip downstream roller 427 forming the nip portion N in the rotation direction of the lower belt 421. Specifically, in the rotation direction of the lower belt 421, the tension roller 4011b is disposed further downstream than the driving roller 4031b downstream of the nip downstream roller 427.

The tension roller 4011b is supported so as to be movable in a predetermined direction (in the present embodiment, an arrow direction illustrated in FIG. 3), and is pressurized by a pressing member (for example, a spring) not illustrated. For example, when the circumferential length of the lower belt 421 fluctuates with respect to a target length due to variations in manufacturing or changes due to use conditions, the tension roller 4011b is pressurized by the pressing member, whereby the stretched state of the lower belt 421 can be stabilized.

Specifically, in the present embodiment, the tension roller 4011b of the lower belt unit 420 is configured to be supported so as to be movable in a horizontal direction (left direction L and right direction R). The tension roller 4011b is disposed such that the tension roller 4011b, the guide roller 4051, the heating portion by the second heating unit 4060b, and the guide roller 428 are arranged in order from the upstream side in the rotation direction of the lower belt 421. With the arrangement of the present embodiment, even when the position of the tension roller 4011b moves in the horizontal direction due to the variation in the circumferential length of the lower belt 421, it is possible to suppress the variation in the distance between the second heating unit 4060b and the lower belt 421. Meanwhile, the tension roller 4011a of the upper belt 411 is also configured to be supported so as to be movable in the horizontal direction.

### Steering Roller

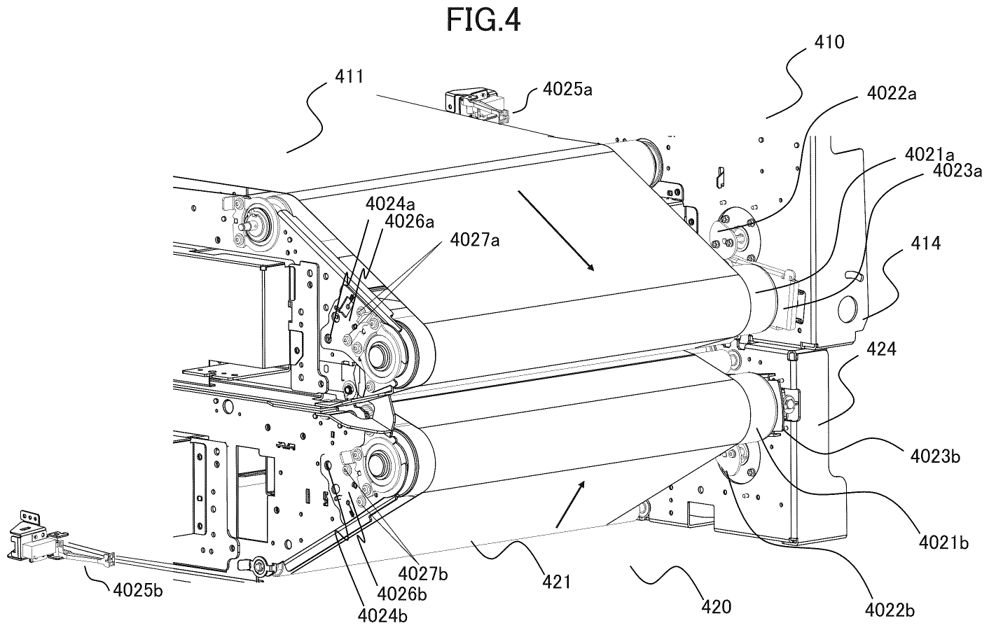

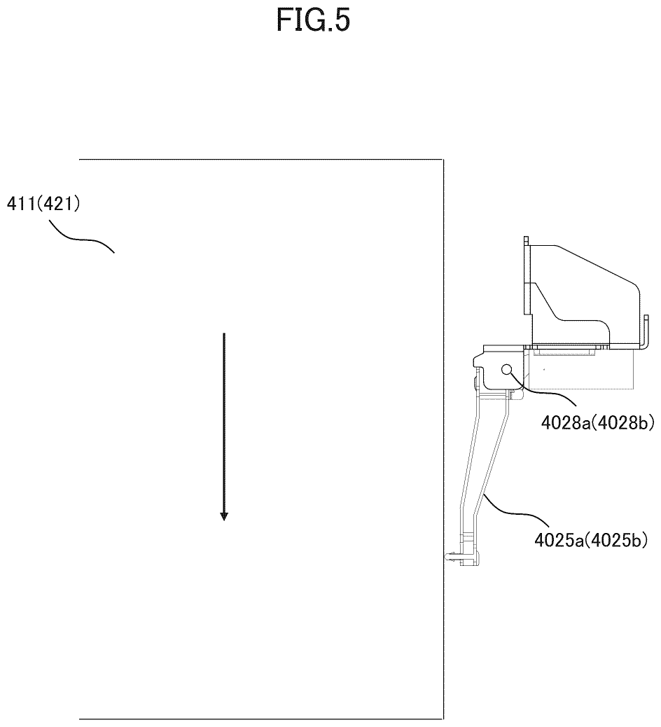

Next, the steering roller 4021b will be described with reference to FIGS. 3 to 5. FIG. 4 is a schematic perspective view illustrating the vicinity of the steering roller of the fixing belt unit 4100. FIG. 5 is a plan view illustrating a relationship between the upper belt 411 (lower belt 421) and the edge sensor 4025a (4025b). One of the plurality of stretching rollers provided in the lower belt unit 420 is a steering roller 4021b for controlling the position of the lower belt 421 in a front-rear direction (front direction F and rear direction B, width direction of lower belt 421).

The steering roller 4021b is a metal roller made of, for example, aluminum, iron, or the like. A first end of the steering roller 4021b in the front-rear direction is rotatably supported by a fixing plate 4026b. The fixing plate 4026b is fastened to the lower frame 424 with a screw 4027b or the like. A second end side of the steering roller 4021b in the front-rear direction is rotatably supported by a steering arm 4023b. The steering arm 4023b is supported by the lower frame 424 so as to be rotatable about a rotation center 4024b. A steering cam 4022b having an eccentric radius abuts on a part of the steering arm 4023b, and the alignment of the steering roller 4021b can be changed by rotating the steering cam 4022b by a steering motor (not illustrated).

Further, the fixing plate 4026b is configured to be able to move the rotation center position of the steering roller 4021b by loosening the fastening of the screw 4027b with respect to the lower frame 424, and is configured to be able to adjust the alignment by re-fastening. For example, it is possible to finely adjust the optimum alignment position of the steering roller 4021b due to variations in installation environment or the like.

A nip upstream guide roller 425 is disposed downstream of the steering roller 4021b provided in the lower belt unit 420 in the rotation direction of the lower belt 421. This is to stabilize the trajectory of the lower belt 421 immediately before the nip portion N regardless of the posture of the steering roller 4021b. When the conveyed sheet S enters the nip portion N, it is possible to stabilize the entry by conveying the sheet S in a posture along the lower belt 421.

Next, a point of controlling the position of the lower belt 421 in the front-rear direction by the steering roller 4021b will be described with reference to FIGS. 4 and 5. Here, since the configurations of the upper belt unit 410 and the lower belt unit 420 are slightly different, each will be described.

First, at a first end portion (end portion on the front direction F side in the present embodiment) of the lower belt 421 in the front-rear direction, an edge sensor 4025b for detecting a position of the lower belt 421 in the front direction F in contact with an end surface of the lower belt 421 is provided in a portion on the lower direction D side of the lower belt 421. In the lower belt unit 420, the guide roller 428 is arranged such that the surface of the lower belt 421 stretched by the tension roller 4011b and the guide roller 428 is substantially parallel to the moving direction (horizontal direction) of the tension roller 4011b. By providing the edge sensor 4025b between the tension roller 4011b and the guide roller 428, the influence of the belt trajectory due to the variation in the circumferential length of the lower belt 421 on the edge sensor 4025b is reduced.

The rotation amount of the steering cam 4022b is controlled by the detection value of the edge sensor 4025b. The rotation center 4028b of the edge sensor 4025b is set such that when the lower belt 421 rotates, the edge sensor 4025b receives a force in a direction in which the edge sensor 4025b is separated by a frictional force received from the lower belt 421. As a result, the load acting on the edge sensor 4025b and the end surface of the lower belt 421 can be reduced.

Meanwhile, at the second end portion (end portion on the rear direction B side in the present embodiment) of the upper belt 411 in the front-rear direction, the edge sensor 4025a for detecting the position of the upper belt 411 in the rear direction B in contact with the end surface of the upper belt 411 is provided in a portion on the upper direction U side of the upper belt 411. In the upper belt unit 410, the guide roller 4051a is disposed such that the surface of the upper belt 411 stretched by the tension roller 4011a and the guide roller 4051a is substantially parallel to the moving direction (horizontal direction) of the tension roller 4011a. By providing the edge sensor 4025a between the tension roller 4011a and the guide roller 4051a, the influence of the belt trajectory due to the variation in the circumferential length of the upper belt 411 on the edge sensor 4025a is reduced.

The rotation amount of the steering cam 4022a is controlled by the detection value of the edge sensor 4025a. A rotation center 4028a of the edge sensor is set such that edge sensor 4025a receives a force in a direction in which the edge sensor 4025a is separated by a frictional force received from the upper belt 411 when the upper belt 411 rotates. As a result, the load acting on the edge sensor 4025a and the end surface of the upper belt 411 can be reduced.

As illustrated in FIG. 5, by disposing the edge sensor 4025b at the end portion on the front direction F side and the portion on the down direction D side of the lower belt 421 and disposing the edge sensor 4025a at the end portion on the rear direction B side and the portion on the upper direction U side of the upper belt 411, the edge sensors having the same shape can be used for the upper belt 411 and the lower belt 421.

In addition, although the steering roller in the present embodiment is a metal roller, a roller having a rubber layer such as heat resistant rubber on a surface thereof may be used in order to enhance the steering performance by increasing the frictional force. In addition, the alignment is changed by fixing a first end of the steering roller and moving the second end side, but both ends may be movably supported and the alignment may be changed.

### Driving Roller

Next, the driving roller 403 1b will be described with reference to FIG. 3. One of the plurality of stretching rollers provided in the lower belt unit 420 is a driving roller 4031b for applying a driving force to the lower belt 421.

The driving roller 4031b is a metal roller made of, for example, aluminum, iron, or the like. Both ends of the driving roller 4031b in the front-rear direction are rotatably supported with respect to the lower frame 424, and when driving is input using a drive transmission mechanism (not illustrated) such as a gear and a timing belt, the driving roller rotates the lower belt 421 in a predetermined direction by a frictional force.

In the present embodiment, the lower belt 421 and the upper belt 411 rotate by independently applying driving force by the driving roller 4031a and the driving roller 4031b. Although the driving roller in the present embodiment is a metal roller, a roller having a rubber layer such as heat-resistant rubber on the surface may be used in order to increase the driving force by increasing the frictional force.

### Details of Nip Portion

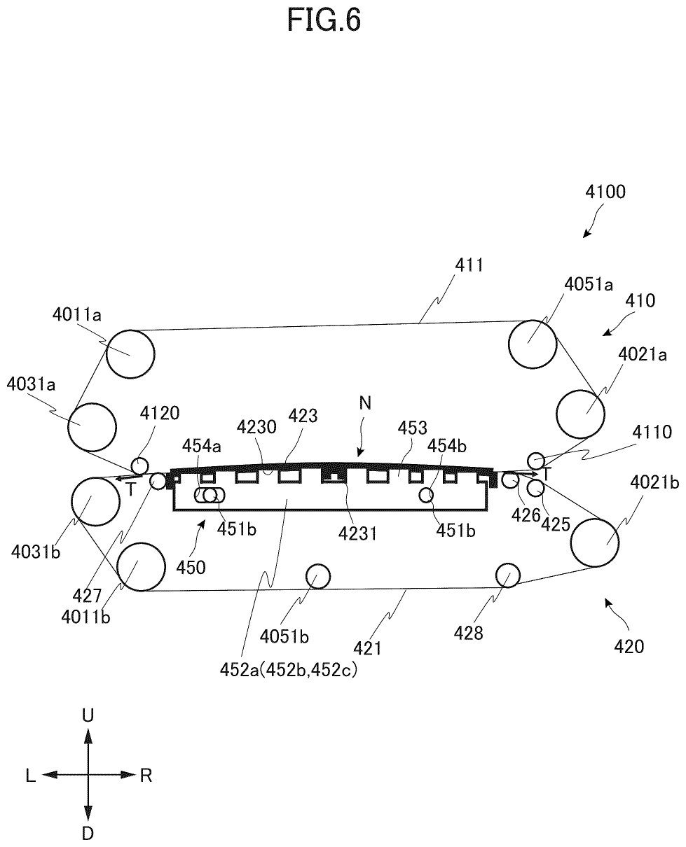

Next, a forming portion of the nip portion N will be described with reference to FIGS. 6 to 9 while referring to FIG. 3. In order to provide a high-quality product in the fixing module 4000 as described above, it is required to sufficiently heat the toner image on the sheet at a low temperature. Therefore, the nip portion N between the upper belt unit 410 and the lower belt unit 420 is required to stably form a uniform nip in a wide nip region with a low nip pressure. For this purpose, it is necessary to stably press the upper belt 411 and the lower belt 421 against the pad 423 that supports the lower belt 421 from the inner peripheral surface in the region of the nip portion N. In order to stably achieve a uniform nip pressure in a wide range of the nip portion N, it is required to accurately support the pad 423.

Therefore, in the present embodiment, the following configuration is adopted so that the stable nip portion N can be formed. FIG. 6 is a schematic view illustrating a cross section of the fixing belt unit 4100. As described above, the pad 423 forming the nip portion Nis disposed in the lower belt unit 420, and forms a curved surface having a convex shape with respect to the nip surface in the sheet conveyance direction (the left-right direction in FIG. 6) in the nip portion N. That is, the pad 423 is a plate-shaped member, and has a crown shape curved such that a central portion in the conveyance direction protrudes toward the upper belt 411 than both end portions. The nip upstream roller 426 and the nip downstream roller 427 are disposed on both sides of the pad 423 in the conveyance direction.

The upper belt unit 410 is provided with the inlet roller 4110 on the upstream side in the conveyance direction of the portion facing the nip upstream roller 426 and the outlet roller 4120 on the downstream side in the conveyance direction of the portion facing the nip downstream roller 427. By pressing the upper belt 411 stretched between the inlet roller 4110 and the outlet roller 4120 against the lower belt 421 supported by the pad 423, the nip upstream roller 426 and the nip downstream roller 427, a uniform nip with a low nip pressure is formed between the upper belt 411 and the lower belt 421 in a wide range, particularly in a nip portion long in the conveyance direction.

In this case, the pressure applied to the nip portion N is determined by the tension T applied to the upper belt 411 in the upper belt unit 410, the curvature of the pad 423 in the lower belt unit 420, and the density and thickness of the lower belt 421. Therefore, by accurately forming the curvature of the pad 423 at the nip portion N, the nip pressure can be made low and uniform in a wide range of the nip portion N. In the present embodiment, the pad holder 450 is disposed on the back surface of the pad 423 forming the nip portion N, that is, on the surface opposite to the lower belt 421, and holds the pad 423 in a curved state.

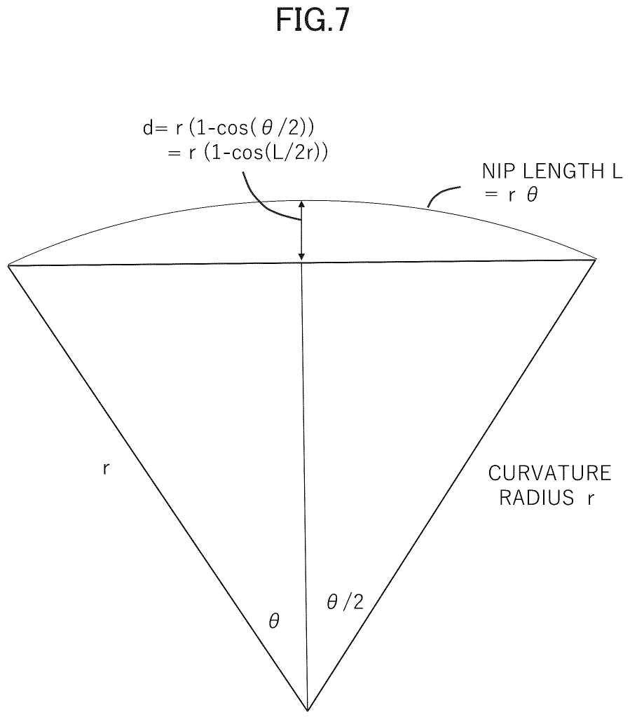

The curvature of the pad 423 will be described with reference to FIG. 7. In order to make the nip pressure uniform and low in a wide range of the nip portion N, it is required to make a relationship between the curvature radius r of the pad 423 and the length (nip length L) of the nip portion N in the sheet conveyance direction appropriate. The necessary nip length L is determined by the conveyance speed of the sheet and the heat transfer time from the belt to the sheet. Meanwhile, the curvature radius of the pad 423 is determined by the sheet conveying property and the nip pressure in the nip portion N. Therefore, it is preferable to determine the curvature radius of the pad 423 in consideration of these.

Here, in a case where a direction orthogonal to the sheet conveyance direction and orthogonal to the width direction is the height direction, a difference d between the highest position and the lowest position of the pad 423 in the height direction is obtained as r(1−cos(θ/2))=r(1−cos(L/2r) from FIG. 7. The highest position of the pad 423 is defined as a central position in the conveyance direction, and the lowest position is defined as both end portions in the conveyance direction. θ is an angle formed by a pair of lines connecting both end portions of the pad 423 in the conveyance direction and the center of curvature, and the nip length L is rθ. Then, the above-described difference d can be expressed by r(1−cos(L/2r)). The difference d is preferably 2 mm or more and 200 mm or less, and in the present embodiment, the difference d is about 5 mm.

In the present embodiment, the curvature of the pad 423 set as described above is held by the pad holder 450. In particular, the pad 423 is a plate-shaped member having a crown shape, and it is difficult to ensure sufficient stiffness by itself. Therefore, in the present embodiment, by supporting the pad 423 having low stiffness by the pad holder 450, the curvature of the pad 423 is maintained even when an external force acts on the pad 423 in the formation state of the nip portion N. When the curvature of the pad 423 can be maintained, the nip pressure can be made low and uniform in a wide range of the nip portion N as described above.

### Pad Holder

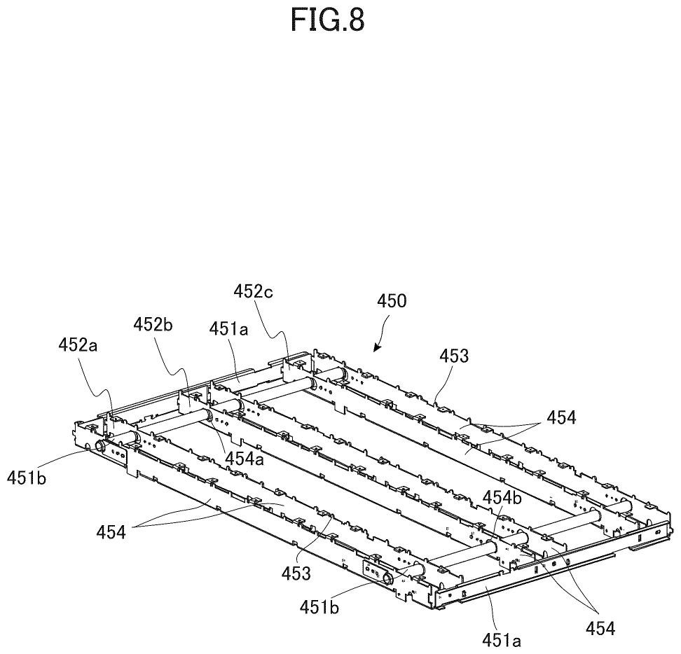

As illustrated in FIG. 8, the pad holder 450 includes three supporting members 452a, 452b, and 452c, a pair of connecting members 451a, and shaft members 451b serving as positioning members. The three supporting members 452a, 452b, and 452c are disposed along the conveyance direction of the sheet at the nip portion N, and are in contact with different positions in the width direction of the sheet intersecting the conveyance direction among the surfaces (hereinafter, back surface 4230) of the pad 423 on the side opposite to the lower belt 421 to support the pad 423. At least three supporting members 452a, 452b, and 452c may be provided, and four or more supporting members may be provided.

One supporting member 452b of the three supporting members 452a, 452b, 452c is disposed at the central portion in the width direction. Further, two supporting members 452a and 452c of the three supporting members 452a, 452b, and 452c are disposed outside the maximum image region with respect to the sheet having the maximum size conveyed in the nip portion in the width direction. Specifically, the supporting member 452b is disposed at the central portion in the width direction of the pad 423, and the supporting members 452a and 452c are disposed at both end portions in the width direction of the pad 423. Each of the three supporting members 452a, 452b, and 452c has a U-shaped cross section taken along the width direction, and the distal end side of the U-shaped cross section comes into contact with the pad 423.

That is, each of the three supporting members 452a, 452b, and 452c is formed so as to fold both end portions in the lateral direction of the plate-shaped member (for example, a metal plate such as iron), and includes a bottom plate portion facing the back surface 4230 of the pad 423 and a pair of bent plate portions 454 bent from both ends in the lateral direction of the bottom plate portion toward the back surface 4230. The distal end sides of the pair of bent plate portions 454 are brought into contact with the pad 423. As will be described in detail below, a plurality of protrusions 453 are formed at the distal end portions of the pair of bent plate portions 454, and the plurality of protrusions 453 are brought into contact with the back surface 4230 of the pad 423.

The three supporting members 452a, 452b, and 452c are formed by bending a plate-shaped member in this manner, so that stiffness in a direction in which the curvature of the pad 423 changes can be enhanced. In particular, since the bent corner portions of the supporting members 452a, 452b, and 452c extend in the direction along the conveyance direction, stiffness against bending of the supporting members 452a, 452b, and 452c with respect to the conveyance direction can be increased. By supporting the pad 423 by the supporting members 452a, 452b, and 452c, it is easy to maintain the curvature of the pad 423 long in the conveyance direction.

The connecting members 451a connects the three supporting members 452a, 452b, and 452c. When there are four or more supporting members, the connecting members 451a connects all the supporting members. In the present embodiment, a pair of connecting members 451a is disposed so as to connect both end portions of the three supporting members 452a, 452b, and 452c in the conveyance direction. The pair of connecting members 451a is disposed along the width direction. The connecting member 451a is disposed at a position not in contact with the back surface 4230 of the pad 423. That is, the upper ends of the pair of connecting members 451a are located at positions lower than the upper ends of the three supporting members 452a, 452b, and 452c in the height direction. As described above, the height direction is a direction orthogonal to the conveyance direction of the sheet in the nip portion N and orthogonal to the width direction, and is an up-down direction in FIG. 6.

The shaft members 451b are disposed along the width direction at positions closer to the center side than the pair of connecting members 451a in the conveyance direction. The shaft members 451b positions the three supporting members 452a, 452b, and 452c in the height direction. Specifically, as illustrated in FIGS. 6 and 8, the shaft member 451b is inserted into the through holes 454a and 454b formed in the three supporting members 452a, 452b, and 452c, thereby positioning the three supporting members 452a, 452b, and 452c in the height direction.

In the present embodiment, two shaft members 451b are provided, and the supporting members 452a, 452b, and 452c are positioned in the height direction at positions close to both ends in the conveyance direction. The through holes 454a and 454b are formed in the bent plate portions 454 of the supporting members 452a, 452b, and 452c, respectively. One through hole 454a has a width in the height direction slightly larger than the outer diameter of the shaft member 451b so as to be fitted to the shaft member 451b in the height direction, but has a width in the conveyance direction larger than the outer diameter of the shaft member 451b. The other through hole 454b has an inner diameter slightly larger than the outer diameter of the shaft member 451b, and is fitted to the shaft member 451b.

In this manner, by making the through hole 454a of one of the through holes 454a and 454b long in the conveyance direction, a gap in the conveyance direction exists between the shaft member 451b and the through hole 454a, so that it is possible to suppress deformation of the pad 423 due to a temperature difference between the shaft member 451b and the pad 423. In addition, by making the one through hole 454a an elongated hole, the shaft member 451b can be easily assembled to the supporting members 452a, 452b, and 452c regardless of the tolerance between the components. Further, by positioning the plurality of supporting members 452a, 452b, 452c by the plurality of shaft members 451b long in the width direction as described above, the height of the pad 423 can be easily kept uniform in the conveyance direction.

That is, in order to achieve a uniform height of the pad 423, a reference member that does not bend even when receiving an external force in the height direction is required. This reference can then be made at two points with respect to the conveyance direction orthogonal to the height direction. In the present embodiment, the positions in the height direction of the supporting members 452a, 452b, and 452c are defined by making this reference with the two shaft members 451b at positions separated in the conveyance direction. Note that the two shaft members 451b are parts having the same shape, but may be parts having different shapes as long as the positions of the supporting members 452a, 452b, and 452c in the height direction can be defined.

In addition, as long as at least one of the pair of connecting members 451a functions as positioning of the supporting members 452a, 452b, and 452c in the height direction, the number of the shaft members 451b may be one. For example, the one connecting member 451a may be configured to have stiffness enough to position the supporting members 452a, 452b, and 452c in the height direction, and one shaft member 451b may be disposed at a position away from the connecting member 451a in the conveyance direction.

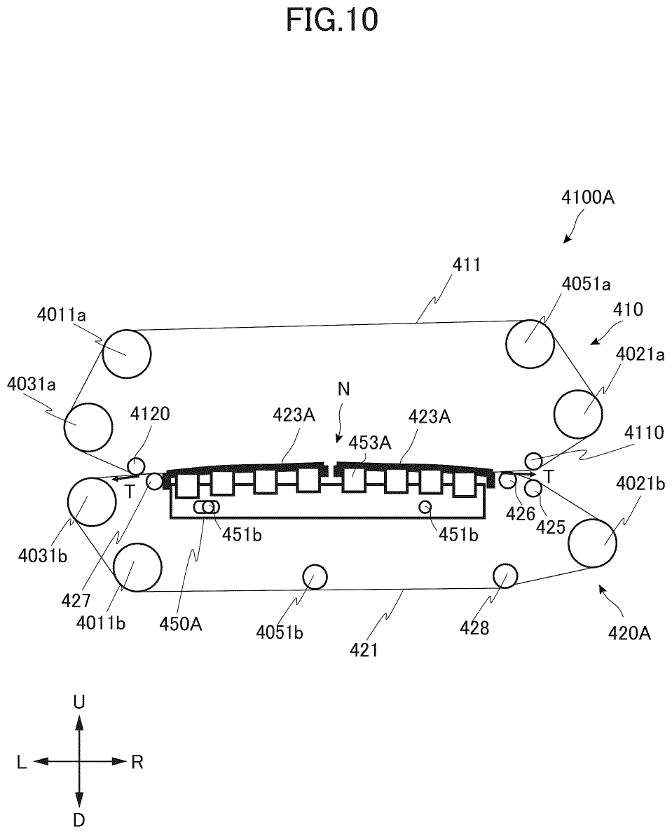

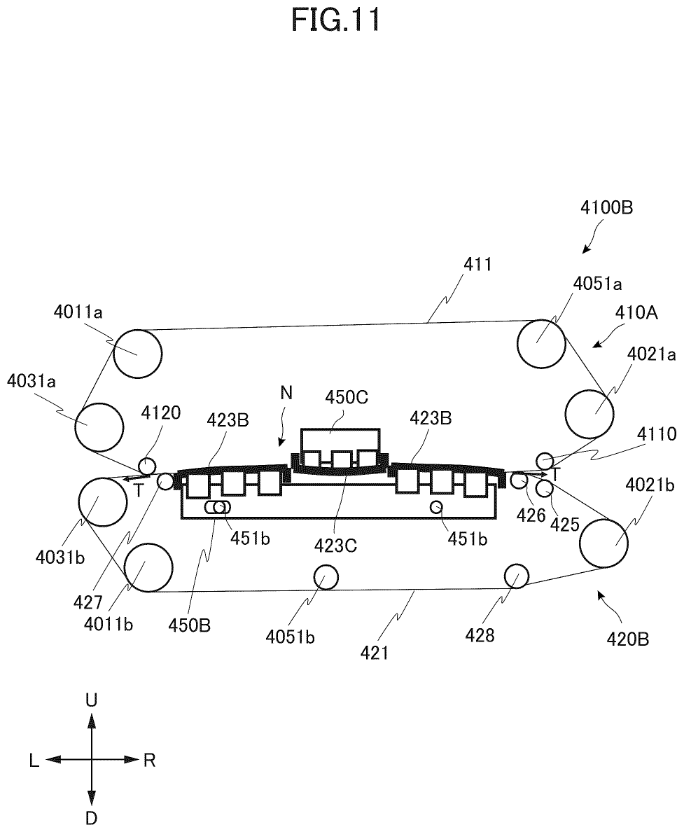

As described above, each of the three supporting members 452a, 452b, and 452c has the plurality of protrusions 453 protruding toward the pad 423. In FIG. 6, the plurality of protrusions 453 are exaggeratedly and largely illustrated, but the plurality of protrusions 453 actually have a small shape as illustrated in FIG. 8. The same applies to FIGS. 10 and 11 described below. The plurality of protrusions 453 contact different positions with respect to the conveyance direction of the back surface 4230 of the pad 423 so as to hold the pad 423 in a crown shape having a curvature as described above.

That is, the protrusion amount of each of the plurality of protrusions 453 is defined in accordance with the curvature of the pad 423, and each of the protrusions abuts on the back surface 4230 of the pad 423, so that the curvature of the pad 423 can be maintained regardless of the nip pressure of the nip portion N. The plurality of protrusions 453 are formed at the distal ends of the bent plate portions 454 of the three supporting members 452a, 452b, and 452c, respectively. Therefore, the back surface 4230 of the pad 423 is also supported by the protrusion 453 at a plurality of places in the width direction.

In addition, by bringing the protrusions 453 into contact with the back surface 4230 of the pad 423 at a plurality of places in this manner, the contact area between the supporting members 452a, 452b, and 452c and the pad 423 is reduced, and the heat transfer from the nip surface to the pad holder 450 via the pad 423 is reduced. In the present embodiment, the plurality of protrusions 453 are formed integrally with the supporting members 452a, 452b, and 452c, but may be formed separately from the supporting members 452a, 452b, and 452c and fixed to the supporting members 452a, 452b, and 452c, similarly to the configuration illustrated in FIG. 10 to be described below.

### Pad

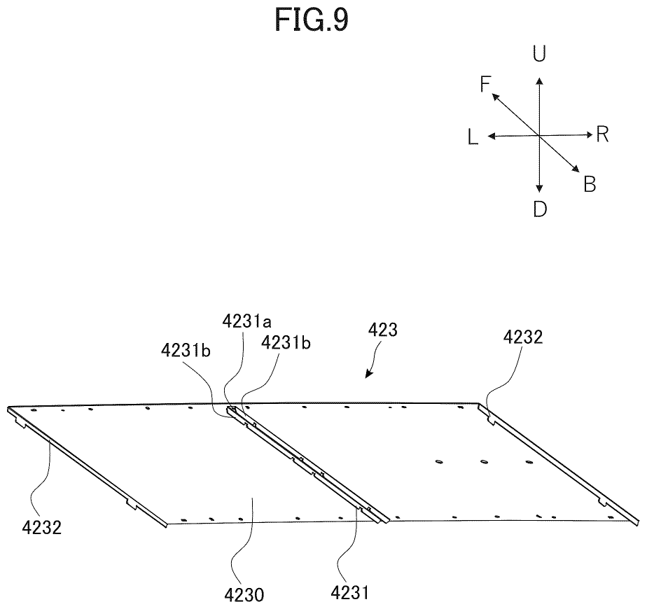

Next, the configuration of the pad 423 will be described with reference to FIG. 9. The pad 423 has a plurality of embossed shapes on a surface in contact with the inner peripheral surface of the lower belt 421. Accordingly, when the nip portion N is formed, friction between the surface of the pad 423 and the lower belt 421 can be reduced. As a result, the lower belt 421 slides smoothly with respect to the pad 423, and the driving torque of the lower belt 421 can be suppressed. In addition, by having a plurality of embossed shapes on the surface of the pad 423, the contact area between the lower belt 421 and the pad 423 can be reduced, and heat transfer from the nip surface to the pad 423 can be reduced.

FIG. 9 is a view of the pad 423 as viewed from the back surface 4230 side. The pad 423 includes a reinforcing member 4231 and bent portions 4232 provided along the width direction. The reinforcing member 4231 serving as a reinforcing portion is a member separate from the pad 423, and is fixed to a central portion in the conveyance direction on the back surface 4230 of the pad 423. The reinforcing member 4231 has a shape in which both end portions in the lateral direction of a plate-shaped member are bent, and has a U-shaped cross section orthogonal to the longitudinal direction. That is, the reinforcing member 4231 includes a bottom plate portion 4231a fixed to the back surface 4230 of the pad 423 and a pair of bent plate portions 4231b bent from both ends of the bottom plate portion 423 la in the lateral direction toward the direction opposite to the back surface 4230.

The reinforcing member 4231 is fixed to the back surface 4230 of the pad 423 by, for example, welding such that the longitudinal direction is the width direction. Therefore, the bent corner portion of the reinforcing member 4231 extends in the direction along the width direction orthogonal to the conveyance direction. Therefore, stiffness against bending of the reinforcing member 4231 in the width direction can be increased. The reason why the reinforcing member 4231 is provided such that the longitudinal direction is along the width direction with respect to the pad 423 is that, if the reinforcing member is provided such that the longitudinal direction is along the conveyance direction, the bent corner portion is in the direction along the conveyance direction. Therefore, when the reinforcing member 4231 is provided on the pad 423 along the conveyance direction, the crown shape of the pad 423 curved in the conveyance direction is affected. Further, the stiffness of the reinforcing member 4231 can be easily increased by bending a plate-shaped member. Therefore, in order not to affect the crown shape of the pad 423 curved in the conveyance direction even if the reinforcing member 4231 is provided on the pad 423, it is necessary to form the reinforcing member 4231 itself into a shape along the crown shape, which increases the manufacturing cost.

Note that the reinforcing member 4231 may be integrated with the pad 423, and may be formed by, for example, bending a part of the pad 423. A plurality of reinforcing members 4231 may be disposed at different positions in the conveyance direction of the back surface 4230 of the pad 423. Even in this case, each of the reinforcing members 4231 is disposed along the width direction.

The bent portions 4232 serving as the reinforcing portion is formed by bending both end portions of the pad 423 in the conveyance direction to the opposite side of the lower belt 421. Since the bent corner portion of the bent portions 4232 also extends in the direction along the width direction orthogonal to the conveyance direction, stiffness against bending in the width direction is high, and bending stiffness of the pad 423 in the width direction can be increased. As described above, in the present embodiment, since the pad 423 is reinforced by the reinforcing member 4231 and the bent portions 4232, the bending stiffness of the pad 423, which is a plate-shaped member, in the width direction can be increased. Note that the above-described reinforcing member 4231 may be provided at both end portions of the pad 423 in the conveyance direction without bending both end portions of the pad 423 in the conveyance direction.

In the pad 423, a thermal step generated by the sheet passing through the nip portion N taking heat from the nip surface is generated in a passing portion through which the sheet has passed and a non-passing portion deviated from the passing portion. The thermal step is generated in the width direction orthogonal to the conveyance direction of the sheet of the pad 423, and exerts a force to curve the pad 423 in the width direction. When the pad 423 is curved in the width direction, the nip pressure varies. Therefore, as described above, by providing the reinforcing member 4231 and the bent portions 4232 in the width direction with respect to the pad 423, it is possible to prevent the pad 423 from being curved in the width direction and to suppress the occurrence of variation in the nip pressure.

As described above, in the present embodiment, since the pad 423 is held by the pad holder 450, the curvature shape of the pad 423 can be accurately maintained, and the nip pressure can be made low and uniform in a wide range of the nip portion N. That is, since the pad 423 is supported by bringing at least three supporting members 452a, 452b, and 452c into contact with the back surface 4230 of the pad 423, the bending stiffness of the pad 423 with respect to the conveyance direction can be increased, and the curvature of the pad 423 can be maintained. Further, since the supporting members 452a, 452b, and 452c are positioned in the height direction by the shaft member 451b, the supporting members 452a, 452b, and 452c can be accurately brought into contact with the back surface 4230 of the pad 423. Furthermore, since the pad 423 is reinforced by the reinforcing member 4231 and the bent portion 4232 provided along the width direction, flexural stiffness in the width direction can also be secured. As a result, the curvature shape of the pad 423 can be accurately maintained, and a uniform nip pressure can be stably achieved in a wide range of the nip portion N.

In the above-described embodiment, the pad 423 is arranged on the lower belt unit 420, and the inlet roller 4110 and the outlet roller 4120 are arranged on the upper belt unit 410. Meanwhile, a configuration in which the upper belt unit 410 and the lower belt unit 420 are interchanged, that is, a configuration in which the upper belt unit and the lower belt unit are upside down may be adopted. That is, even in a configuration in which the inlet roller and the outlet roller are arranged in the lower belt unit and the pad is arranged in the upper belt unit, the same effect can be obtained by the same configuration as described above.

### Second Embodiment

A second embodiment will be described with reference to FIG. 10. In the first embodiment described above, the nip portion N is formed by one pad 423. Meanwhile, in the present embodiment, the nip portion N is formed by a plurality of pads 423A. Other configurations and operations are similar to those of the first embodiment described above. For this reason, the same components as those of the first embodiment are denoted by the same reference numerals, description and illustration thereof are omitted or simplified, and hereinafter, differences from the first embodiment will be mainly described.

In a fixing belt unit 4100A of the present embodiment, a plurality of pads 423A are arranged in the conveyance direction in a lower belt unit 420A. In the illustrated example, the two pads 423A are arranged side by side in the conveyance direction via a gap. Then, the two pads 423A are brought into contact with the inner peripheral surface of the lower belt 421, and the lower belt 421 is supported by the two pads 423A, thereby forming the nip portion N between the upper belt 411 and the lower belt 421. The two pads 423A are supported by one pad holder 450A such that their curvatures are maintained.

The basic configuration of the pad holder 450A is similar to that of the first embodiment, but in the present embodiment, a plurality of protrusions 453A are formed separately from the supporting members 452a, 452b, and 452c (see FIG. 8) constituting the pad holder 450, and the plurality of protrusions 453A are fixed to the supporting members 452a, 452b, and 452c. By forming the plurality of protrusions 453A separately from the supporting members 452a, 452b, and 452c, the protrusion amounts of the protrusions 453A from the supporting members 452a, 452b, and 452c can be adjusted. Therefore, the protrusion amounts of the plurality of protrusions 453A can be adjusted according to the curvature shape of the pad supported by the pad holder 450A. Also in the present embodiment, similarly to the first embodiment, the plurality of protrusions 453A may be integrated with the supporting members 452a, 452b, and 452c. In addition, the number of the pad holders 450A may be two in accordance with the number of the pads 423A, and the pads 423 A may be supported by different pad holders 450.

In addition, the configuration of each pad 423A is basically the same as that of the pad 423 of the first embodiment, but the length in the conveyance direction is different. The curvatures of the two pads 423A are set to be similar to the curvature of the one pad 423 of the first embodiment in a state where the two pads 423A are arranged in the conveyance direction. In addition, the gap between the two pads 423A is preferably set to a width that prevents the lower belt 421 from separating from the sheet when the sheet passes, and is further preferably suppressed to a width that prevents the lower belt 421 from loosening. This gap is, for example, 1 mm or more and 100 mm or less. In the illustrated example, the reinforcing member 4231 that reinforces the central portion of the pad 423A is not provided, but may be provided. The number of pads 423A may be 3 or more. Also in the present embodiment, the upper belt unit 410 and the lower belt unit 420A may be interchanged.

### Third Embodiment

A third embodiment will be described with reference to FIG. 11. In the second embodiment described above, the configuration in which the two pads 423 A are arranged in the lower belt unit 420A has been described. Meanwhile, in the present embodiment, the pads 423B and 423C are arranged in the upper belt unit 410A and the lower belt unit 420B, respectively. Other configurations and operations are similar to those of the first embodiment described above. For this reason, the same components as those of the first embodiment are denoted by the same reference numerals, description and illustration thereof are omitted or simplified, and hereinafter, differences from the first embodiment will be mainly described.

In the fixing belt unit 4100B of the present embodiment, two pads 423B serving as first nip portion forming members are arranged in the lower belt unit 420B, and a pad 423C serving as a second nip portion forming member is arranged in the upper belt unit 410A. The two pads 423B are supported by the pad holder 450B. The pad holder 450B has the same configuration as the pad holder 450A of the second embodiment except that the pad is not supported in a range where the pad 423C is located in the conveyance direction. In the present exemplary embodiment, the supporting members 452a, 452b, 452c (see FIG. 8) of the pad holder 450B correspond to the first supporting member, and the pair of connecting members 451a (see FIG. 8) of the pad holder 450B correspond to the first connecting member.

The pad 423C forms the nip portion N between the upper belt 411 and the lower belt 421 by abutting on the inner peripheral surface of the upper belt 411 and supporting the upper belt 411. The pad 423C is supported by the pad holder 450C. The configuration of the pad holder 450C is similar to that of the pad holder 450A of the second embodiment except for the length in the conveyance direction. At least three supporting members (second supporting members) 452a, 452b, and 452c (see FIG. 8) of the pad holder 450C are disposed along the sheet conveyance direction in the nip portion N, and come into contact with different positions in the sheet width direction intersecting the conveyance direction of the surfaces of the pad 423C opposite to the upper belt 411 to support the pad 423C. The pair of connecting members (second connecting members) 451a (see FIG. 8) of the pad holder 450C connects the at least three supporting members (second supporting members) 452a, 452b, and 452c.

In the present embodiment, the pad 423B and the pad 423C are arranged at different positions in the conveyance direction. That is, the nip portion N is formed by the two pads 423B on the lower belt unit 420B side on both sides of the nip portion N in the conveyance direction, and the nip portion N is formed by the pad 423C of the upper belt unit 410A between the two pads 423. That is, in the present embodiment, the pads 423B and 423C adjacent in the conveyance direction are alternately arranged inside the lower belt 421 and inside the upper belt 411. In addition, a gap exists between the pads 423B and 423C similarly to the second embodiment. A conveying roller may be disposed between the adjacent pads to assist the conveying force of the sheet. Also in the present embodiment, the upper belt unit 410A and the lower belt unit 420B may be interchanged.

### Other Embodiments

In each of the above-described embodiments, the case where the present disclosure is applied to the fixing belt units 4100, 4100A, and 4100B as the sheet conveyance apparatus has been described, but the sheet conveyance apparatus of the present disclosure is not limited thereto, and can be applied to a device having a pair of belts on both sides sandwiching the conveying surface of the sheet. For example, the present disclosure can also be applied to the cooling module 5000 (cooling device).

Furthermore, in each of the above-described embodiments, the case of being applied to the image forming system 1 serving as the image forming apparatus has been described, but the present disclosure is not limited thereto. For example, the present disclosure can also be applied to an electrophotographic image forming apparatus using a toner, and the same effects as those of the present embodiment can be obtained.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-174638, filed Oct. 6, 2023, which is hereby incorporated by reference herein in its entirety.

What is claimed is:

1. A sheet conveyance apparatus comprising:
a first belt unit including a rotating endless first belt;
a second belt unit including a rotating endless second belt that forms a nip portion for nipping and conveying a sheet with the first belt,
wherein the first belt unit includes
the first belt, and
a plurality of first stretching members configured to stretch the first belt, and
wherein the second belt unit includes
the second belt,
a plurality of second stretching members configured to stretch the second belt,
at least one nip portion forming member configured to form the nip portion between the first belt and the second belt by abutting on an inner peripheral surface of the second belt and supporting the second belt,
at least three supporting members disposed along a conveyance direction of the sheet in the nip portion, the at least three supporting members being in contact with surfaces of the nip portion forming member on a side opposite to the second belt at different positions in a width direction of the sheet intersecting with the conveyance direction to support the nip portion forming member, and
at least one connecting member configured to connect the at least three supporting members.

2. The sheet conveyance apparatus according to claim 1, wherein the at least three supporting members include
a first supporting member disposed at one end portion in the width direction,
a second supporting member disposed at another end in the width direction, and
a third supporting member disposed between the first supporting member and the second supporting member in the width direction.

3. The sheet conveyance apparatus according to claim 1, wherein two supporting members of the at least three supporting members are disposed outside a maximum image region with respect to a sheet of a maximum size conveyed in the nip portion in the width direction.

4. The sheet conveyance apparatus according to claim 1, wherein each of the at least three supporting members has a U-shaped cross-sectional shape cut along the width direction, and a distal end side of the U-shaped cross-sectional shape is in contact with the nip portion forming member.

5. The sheet conveyance apparatus according to claim 1, wherein the nip portion forming member is a plate-shaped member, and has a crown shape curved such that a central portion in the conveyance direction of the plate-shaped member protrudes toward the first belt than both end portions.

6. The sheet conveyance apparatus according to claim 5, wherein each of the at least three supporting members includes a plurality of protrusions protruding toward the nip portion forming member, and
the plurality of protrusions are in contact with a surface of the nip portion forming member opposite to the second belt at different positions in the conveyance direction so as to hold the nip portion forming member in the crown shape.

7. The sheet conveyance apparatus according to claim 6, wherein the plurality of protrusions are formed integrally with the supporting member.

8. The sheet conveyance apparatus according to claim 6, wherein the plurality of protrusions are separate from the supporting member and are fixed to the supporting member.

9. The sheet conveyance apparatus according to claim 5, wherein the nip portion forming member includes a reinforcing portion provided along the width direction.

10. The sheet conveyance apparatus according to claim 9, wherein the reinforcing portion is a member separate from the nip portion forming member, and is fixed to the central portion in the conveyance direction on a surface of the nip portion forming member opposite to the second belt.

11. The sheet conveyance apparatus according to claim 9, wherein the reinforcing portion is a bent portion obtained by bending the both end portions of the nip portion forming member in the conveyance direction toward the side opposite to the second belt.

12. The sheet conveyance apparatus according to claim 1, wherein the at least one connecting member includes a pair of the connecting members disposed so as to connect both end portions of the at least three supporting members in the conveyance direction, and
the sheet conveyance apparatus further includes a positioning member disposed along the width direction at a position closer to a center side than the pair of connecting members in the conveyance direction and configured to position the at least three supporting members in a height direction orthogonal to the conveyance direction and orthogonal to the width direction.

13. The sheet conveyance apparatus according to claim 1, wherein the at least one nip portion forming members includes a plurality of nip portion forming members disposed in the conveyance direction.

14. The sheet conveyance apparatus according to claim 1, wherein the nip portion forming member is a first nip portion forming member,
the at least three supporting members are a first supporting members,
the connecting member is a first connecting member,
the first belt unit includes
a second nip portion forming member configured to form the nip portion between the first belt and the second belt by abutting on an inner peripheral surface of the first belt and supporting the first belt,
at least three second supporting members disposed along the conveyance direction of the sheet in the nip portion, the at least three second supporting members being in contact with a surface of the second nip portion forming member on a side opposite to the first belt at different positions in the width direction to support the second nip portion forming member, and
a second connecting member configured to connect the at least three second supporting members, and
the first nip portion forming member and the second nip portion forming member are disposed at different positions in the conveyance direction.

15. The sheet conveyance apparatus according to claim 1, wherein the first belt unit includes a first heating device configured to heat the first belt.

16. The sheet conveyance apparatus according to claim 1, wherein the second belt unit includes a second heating device configured to heat the second belt.
